(19) United States
(12) Patent Application Publication
(10) Pub. No.: US 2012/0073909 A1
(43) Pub. Date: Mar. 29, 2012

(54) ELEVATOR DEVICE

(75) Inventors: Rikio Kondo, Tokyo (JP); Masunori Shibata, Tokyo (JP); Jun Hashimoto, Tokyo (JP); Hiroshi Kigawa, Tokyo (JP)

(73) Assignee: MITSUBISHI ELECTRIC CORPORATION, Chiyoda-ku, Tokyo (JP)

(21) Appl. No.: 13/376,643

(22) PCT Filed: Jun. 22, 2009
(86) PCT No.: PCT/JP2009/061333

§ 371 Date: Dec. 7, 2011

(51) Int. Cl. B66B 1/24; B66B 5/02

(52) U.S. Cl. 187/247

(57) ABSTRACT

In an elevator device, when confirming that at least one of a car-position condition and a car-speed condition is satisfied after confirmation of satisfaction of a door-open condition, a brake-operation determining section (51) transmits an operation command for controlling a brake device (20) to demonstrate a braking force for quick stop to a brake-operation command section (52).

### TECHNICAL FIELD

The present invention relates to an elevator device having a function of controlling an operation of a brake device.

### BACKGROUND ART

In a conventional elevator device as described in Patent Literature 1, for example, a car in a door-closed state is configured so as not to move out of a predetermined door-opening zone for ensuring safety of the car in the door-open state. In the conventional elevator device, a brake device for braking rotation of a motor (driving device) and a rope gripper for gripping a rope to restrict movement of the rope are used to brake raising/lowering of the car. Further, in the conventional elevator device, when a position of the car in the door-open state moves out of the door-opening zone, the rope gripper directly brakes the rope. As a result, the car can be stopped with a relatively short running distance of the car.

### CITATION LIST

### Patent Literature

PTL 1: JP 2007-55691 A

### SUMMARY OF INVENTION

### Technical Problem

In the conventional elevator device as described above, the rope gripper is used independently of the brake device. Therefore, there is a problem of increased fabrication cost as compared with a general elevator device using the brake device alone. Moreover, it is necessary to ensure a space for installing the rope gripper in a hoistway. Therefore, a space in which the elevator device is installed is required to be increased. As a result, there is another problem of lowered space efficiency as the entire building.

In order to realize a braking function of the rope gripper in the conventional elevator device as described in Patent Literature 1 with the brake device alone, a maximum braking force of the generally used brake device is required to be further increased. In general, however, when the car, which is being raised/lowered, is to be brought to an emergency stop in case of power failure or the like, the car is slowed down to be stopped (car is stopped relatively slowly) by using the braking force of the brake device. Therefore, in the case where the maximum braking force of the brake device is increased, the car is brought into a sudden-stop state when the car is brought to the emergency stop by using the brake device. As a result, a relatively strong deceleration shock is disadvantageously applied to a passenger(s) in the car.

Besides, when a maximum acceleration torque is output from a motor due to an erroneous operation of a motor drive control function or the like at the time of a floor alignment operation for the car in the door-open state (operation for correcting positional misalignment of the car floor due to stretch of the rope caused by boarding/deboarding of the passengers), a running speed of the car becomes relatively high until the car position moves out of the door-opening zone. If the brake device having the increased maximum braking force is actuated at this time, the car, which is being raised and lowered at a relative high speed, is suddenly stopped. Therefore, even in the case where the maximum acceleration torque is output from the motor due to the erroneous operation of the motor drive control function during the floor alignment operation for the car in the door-open state, a relatively strong deceleration shock is disadvantageously applied to the passenger(s) in the car.

The present invention has been made to solve the problems described above, and has an object to provide an elevator device capable of reducing a deceleration shock generated when an emergency stop is made and dealing with an unexpected operation of a car without using a rope gripper or a brake device having an increased maximum braking force.

### Solution to Problem

An elevator device according to the present invention includes: a car which is raised and lowered in a hoistway; an elevator-door device for opening/closing an elevator doorway including a doorway of the car; a driving device for driving the raising/lowering of the car; a brake device for braking the raising/lowering of the car; an operation control section for controlling an operation of the car; car-position detection means for generating a signal according to a position of the car; car-speed detection means for generating a signal according to a running speed of the car; door open/closed-state detection means for generating a signal according to an open/closed-state of the elevator-door device; and a brake control section for controlling an operation of the brake device based on a command from the operation control section, in which: the brake control section is configured to: monitor the position of the car, the running speed of the car, and the open/closed state of the elevator-door device through an intermediation of the car-position detection means, the car-speed detection means, and the door open/closed-state detection means; confirm whether or not each of a door-open condition which is satisfied when the elevator-door device is an open state, a car-position condition which is satisfied when the position of the car is out of a predetermined door-opening zone, and a car-speed condition which is satisfied when the running speed of the car is equal to or higher than a predetermined speed, is satisfied; and control the brake device to demonstrate a braking force for quick stop for quickly stopping the car being raised and lowered when confirming that at least one of the car-position condition and the car-speed condition, and the door-open condition are both satisfied.

### BRIEF DESCRIPTION OF DRAWINGS

FIG. 1 A configuration diagram illustrating an elevator device according to Embodiment 1 of the present invention.

FIG. 2 A block diagram illustrating a control system for the elevator device illustrated in FIG. 1.

FIG. 3 A flowchart illustrating an operation of a brake controller illustrated in FIG. 2.

FIG. 4 An explanatory graph for illustrating a change in each of a car speed and a car position.

FIG. 5 A block diagram illustrating a part of an elevator device according to Embodiment 2 of the present invention.

FIG. 6 An explanatory graph for illustrating a change in each of a car speed and a car position when each of brake controllers according to Embodiment 1 and Embodiment 3 of the present invention is used.

FIG. 7 A flowchart illustrating an operation of the brake controller according to Embodiment 3 of the present invention.

FIG. 8 An explanatory graph for illustrating a change in each of a car speed and a car position when each of the brake controller according to Embodiment 3 and a brake controller according to Embodiment 4 of the present invention is used.

FIG. 9 A flowchart illustrating an operation of the brake controller according to Embodiment 4 of the present invention.

### DESCRIPTION OF EMBODIMENTS

Hereinafter, embodiments of the present invention are described referring to the drawings.

### Embodiment 1

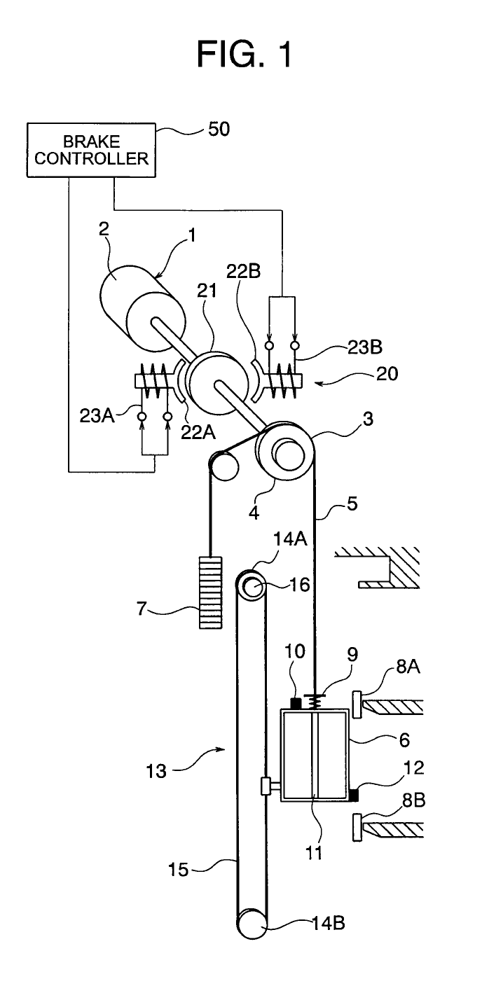

FIG. 1 is a configuration diagram illustrating an elevator device according to Embodiment 1 of the present invention.

In FIG. 1, a hoisting machine 1 is provided in a hoistway of a building. The hoisting machine 1 includes a motor 2 corresponding to a driving device and a sheave 3. The sheave 3 is rotated by the motor 2. A hoisting-machine encoder 4 corresponding to car-speed detection means is mounted to the sheave 3. The hoisting-machine encoder 4 generates an electric signal according to the rotation of the sheave 3.

A main rope 5 is looped around the sheave 3. A car 6 and a counterweight 7 are suspended from the main rope 5. By a driving force of the motor 2, the sheave 3 is rotated. In a portion in which the sheave 3 and the main rope 5 are held in contact with each other, a frictional force is generated. By the frictional force, the main rope 5 is moved with the rotation of the sheave 3. Then, with the movement of the main rope 5, the car 6 and the counterweight 7 are raised and lowered in the hoistway. Specifically, by the driving force of the motor 2, the car 6 and the counterweight 7 are raised and lowered.

A landing-door device (not shown) corresponding to an elevator-door device is provided to a landing at each floor of the building. A landing door opening/closing detector (not shown) corresponding to door open/closed-state detection means is mounted to the landing-door device. The landing door opening/closing detector generates a signal according to an open/closed state of the landing-door device.

At positions of an inner wall of the hoistway, which correspond to floors of the landings, landing plates 8A and 8B are provided along a vertical direction. A car-door device (not shown) corresponding to an elevator-door device for opening/closing a doorway of the car 6 is provided to the car 6. The car 6 is provided with a load-weighing device 9, an acceleration detector 10, a car door opening/closing detector 11 corresponding to door open/closed-state detection means, and a landing-position detector 12 corresponding to car-position detection means.

The load-weighing device 9 generates a signal according to a live load of the car 6. The acceleration detector 10 generates a signal according to a vertical acceleration of the car 6. The car door opening/closing detector 11 generates a signal according to an open/closed state of the car-door device. The landing-position detector 12 is provided at a position of an outer surface of the car 6, which corresponds to the landing plates 8A and 8B. The landing-position detector 12 generates an electric signal by being brought into contact with or approaching any one of the landing plates 8A and 8B.

Further, a governor unit 13 is provided in the hoistway. The governor unit 13 includes an emergency stop device (not shown), a first tension sheave 14A in which a governor main body is incorporated, a second tension sheave 14B, and a governor rope 15. The emergency stop device is provided to the car 6. The first tension sheave 14A is provided in an upper part of the hoistway, whereas the second tension sheave 14B is provided in a lower part of the hoistway. The governor rope 15 is stretched between the first tension sheave 14A and the second tension sheave 14B in an endless fashion. A part of the governor rope 15 is connected to the emergency stop device of the car 6.

The first tension sheave 14A and the second tension sheave 14B are rotated by the movement of the governor rope 15 with the raising/lowering of the car 6. The governor main body included in the tension sheave 14A can mechanically detect that a raising/lowering speed of the car 6 reaches a predetermined overspeed. When detecting that the raising/lowering speed of the car 6 reaches the predetermined overspeed, the governor main body actuates an emergency stop mechanism for the car 6 through an intermediation of, for example, the governor rope 15, thereby stopping the raising/lowering of the car 6. A governor encoder 16 is mounted to the first tension sheave 14A. The governor encoder 16 generates an electric signal according to a rotation speed of the first tension sheave 14A.

A brake device 20 is mounted to the hoisting machine 1. The brake device 20 includes a brake wheel 21, a first brake lining 22A, a second brake lining 22B, a first spring (not shown), a second spring (not shown), a first brake electromagnetic coil 23A, and a second brake electromagnetic coil 23B. The brake wheel 21 is mounted to a rotary shaft of the motor 2. The brake wheel 21 is rotated with the sheave 3.

Each of the first brake lining 22A and the second brake lining 22B is displaceable between a braking position and a release position. The braking position is a position at which the first brake lining 22A and the second brake lining 22B come into contact with a braking surface (for example, an outer circumferential surface) of the brake wheel 21. The release position is a position at which the first brake lining 22A and the second brake lining 22B are separated away from the braking surface of the brake wheel 21. Specifically, the release position is a position at which the first brake lining 22A and the second brake lining 22B are brought into a non-contact state with the braking surface of the brake wheel 21.

The first brake lining 22A and the second braking lining 22B are biased toward the braking surface of the brake wheel 21 respectively by the first spring and the second spring. Therefore, the first brake lining 22A and the second brake lining 22B are pressed against the braking surface of the rotating brake wheel 21 by the first spring and the second spring. As a result, a frictional force is generated between each of the first brake lining 22A and the second brake lining 22B, and the braking surface of the brake wheel 21. By the frictional force, the rotation of the brake wheel 21, that is, the rotation of the motor 2 is braked.

Moreover, the first brake lining 22A and the second brake lining 22B are displaced to the release position against biasing forces of the first spring and the second spring by electromagnetic forces of the first brake electromagnetic coil 23A and the second brake electromagnetic coil 23B, respectively. Excitation/de-excitation of the first brake electromagnetic coil 23A and the second brake electromagnetic coil 23B is controlled by a brake controller 50 corresponding to a brake control section.

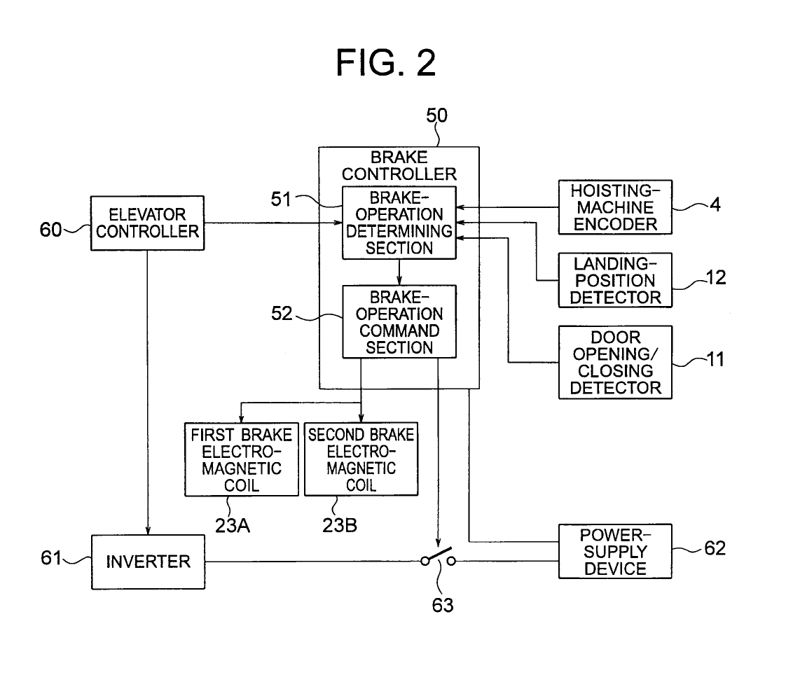

FIG. 2 is a block diagram illustrating a control system of the elevator device illustrated in FIG. 1. In FIG. 2, the raising/lowering of the car 6 and the counterweight 7 is controlled by an elevator controller 60 corresponding to an operation control section. The elevator controller 60 controls driving of the motor 2 of the hoisting machine 1 through an intermediation of an inverter 61 for driving the hoisting machine 1. The inverter 61 is connected to a power-supply device 62. A power interruption switch (hoisting-machine driving power interruption switch) 63 is provided to a power-supply line of the inverter 61. By placing the power interruption switch 63 in an open state, power supply to the inverter 61 is interrupted.

The brake controller 50 includes a brake-operation determining section and a brake-operation command section 52. The brake-operation determining section 51 receives an operation command for a brake operation from the elevator controller 60. The brake-operation determining section 51 receives an electric signal from each of the landing door opening/closing detector, the hoisting-machine encoder 4, the car door opening/closing detector 11, and the landing-position detector 12.

Further, the brake-operation determining section 51 determines the operation of the brake device 20 based on a signal input from each of the devices 60, 4, 11 and 12 (including the landing door opening/closing detector). The brake-operation determining section 51 transmits an operation command corresponding to the determined operation of the brake device 20 to the brake-operation command section 52.

For example, when the car 6 stops at the landing position during normal service (in the case where the following car-position condition and car-speed condition are not satisfied), the brake-operation determining section 51 transmits an operation command for controlling the brake device 20 to demonstrate a braking force for static retention for statically retaining the car 6 to the brake-operation command section 52. On the other hand, when the car 6 leaves the landing position during the normal service, the brake-operation determining section 51 transmits an operation command for releasing the braking force for static retention, of the brake device 20 to the brake-operation command section 52.

The brake-operation determining section 51 uses the electric signal from the hoisting-machine encoder 4 to monitor a running speed of the car 6. Further, the brake-operation determining section 51 uses the electric signal from the car door opening/closing detector 11 to monitor a door open/closed state of the car 6. The brake-operation determining section 51 also uses the electric signal from the landing-position detector 12 to monitor the position of the car 6.

The brake-operation determining section 51 confirms whether or not each of a door-open condition, the car-position condition, and the car-speed condition is satisfied. The door-open condition is a condition which is satisfied when at least one of the car-door device and the landing-door device (specifically, the elevator-door device) is in an open state. The car-position condition is a condition which is satisfied when a car position corresponding to a height position of the car 6 is out of a predetermined door-opening zone (for example, out of the zones of the landing plates 8A and 8B). The car-speed condition is a condition which is satisfied when a car speed corresponding to the running speed of the car 6 is a predetermined speed (for example, a speed which is about half of a rated speed of the car 6) or higher.

The brake-operation command section 52 controls a flow and interruption of the flow of an excitation current through the first brake electromagnetic coil 23A and the second brake electromagnetic coil 23B and a current amount thereof based on an operation command from the brake-operation determining section 51, specifically, according to the determination of the brake-operation determining section 51. When the raising/lowering of the car 6 stops, the brake-operation command section 52 causes the brake device 20 to demonstrate a braking force for normal stop, for statically stopping the car 6 based on the operation command from the brake-operation determining section 51.

Further, when the car 6 is raised and lowered, the brake-operation command section 52 causes the brake device 20 to demonstrate any one of a braking force for slowdown and stop, for slowing down and stopping the car 6 which is being raised and lowered (for decelerating relatively slowly and stopping the car 6) and a braking force for quick stop, for quickly stopping the car 6 which is being raised and lowered based on the operation command from the brake-operation determining section 51.

When causing the brake device 20 to demonstrate the braking force for quick stop and the braking force for static retention, the brake-operation command section 52 interrupts the excitation current through the first brake electromagnetic coil 23A and the second brake electromagnetic coil 23B. In this manner, the brake device 20 demonstrates a maximum braking force determined by spring forces of the first spring and the second spring.

On the other hand, when causing the brake device 20 to demonstrate the braking force for slowdown and stop, the brake-operation command section 52 sets the current amount of the excitation current through the first brake electromagnetic coil 23A and the second brake electromagnetic coil 23B smaller than that used when the brake device 20 is released. As a result, the brake device 20 demonstrates an intermediate braking force which is smaller than the maximum braking force.

The brake-operation command section 52 controls opening/closing of the power interruption switch 63. Further, when the car 6 is normally operated, the brake-operation command section 52 places the power interruption switch 63 in a closed state. When causing the brake device 20 to demonstrate the braking force for quick stop, the brake-operation command section 52 places the power interruption switch 63 in an open state to interrupt the power supply to the inverter 61 so as to forcibly stop the driving of the hoisting machine 1.

When confirming that at least one of the car-position condition and the car-speed condition is satisfied after the confirmation of satisfaction of the door-open condition, the brake-operation determining section 51 transmits the operation command for causing the brake device 20 to demonstrate the braking force for quick stop to the brake-operation command section 52. Then, the brake-operation command section 52 causes the brake device 20 to demonstrate the braking force for quick stop based on the command from the brake-operation determining section 51.

The brake controller 50 can be configured by hardware (not shown) including an arithmetic processing section (CPU), a storage section (such as a ROM, a RAM, and a hard disk), and a signal input/output section. In the storage section of the hardware of the brake controller 50, a program for realizing functions of the brake-operation determining section 51 and the brake-operation command section 52 is stored. Similarly to the brake controller 50, the elevator controller 60 can also be configured by hardware (not shown). In the storage section of the hardware of the elevator controller 60, a program for realizing the functions of the elevator controller 60 is stored.

Next, an operation of the brake controller 50 is described. Here, an example where the brake controller 50 determines whether or not the door-open condition is satisfied only based on the open/closed state of the car-door device is described. However, even the case where the brake controller 50 determines whether or not the door-open condition is satisfied based on the open/closed state of the landing-door device can be dealt with by an operation similar to that described below (the same is applied to Embodiments 3 and 4).

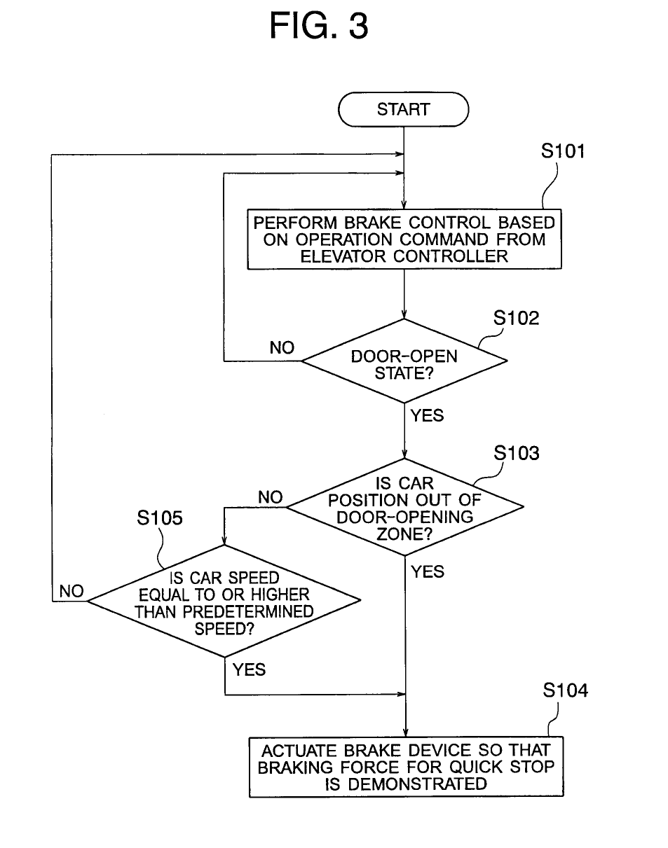

FIG. 3 is a flowchart illustrating an operation of the brake controller 50 illustrated in FIG. 2. In FIG. 3, the brake controller 50 performs brake control based on the operation command from the elevator controller 60 when the car 6 is in a door-closed state (Step S101) and monitors whether or not the car 6 is placed in a door-open state (whether or not the door-open condition is satisfied) (Step S102). When confirming that the car 6 is placed in the door-open state (the door-open condition is satisfied) (Yes direction of Step S102), the brake controller 50 confirms whether or not the car position is out of the door-opening zone (Step S103: confirmation of whether or not the car-position condition is satisfied).

When confirming that the car position is out of the door-opening zone (the car-position condition is satisfied) in this step, the brake controller 50 actuates the brake device 20 so that the braking force for quick stop is demonstrated (Step S104). At the same time, the brake controller 50 places the power interruption switch 63 in the open state to interrupt the power supply to the hoisting machine 1. After that, the brake controller 50 waits until a reset operation is performed by an operator or a recovery operation by the elevator controller 60 is terminated.

On the other hand, when confirming that the car position is within the door-opening zone (the car-position condition is not satisfied), the brake controller 50 confirms whether or not the car speed is equal to or higher than the predetermined speed (Step S105: confirmation of whether or not the car-speed condition is satisfied). When confirming that the car speed is equal to or higher than the predetermined speed (the car-speed condition is satisfied) in this step, the brake controller 50 actuates the brake device 20 so that the braking force for quick stop is demonstrated (Step S104).

At the same time, the brake controller 50 places the power interruption switch 63 in the open state to interrupt the power supply to the hoisting machine 1. After that, the brake controller 50 waits until a reset operation is performed by an operator or a recovery operation by the elevator controller 60 is terminated.

When confirming that the car speed is lower than the predetermined speed (the car-speed condition is not satisfied) (in Step S105), the brake controller 50 performs the brake control based on the operation command from the elevator controller 60 (Step S101) and repeats the same operation.

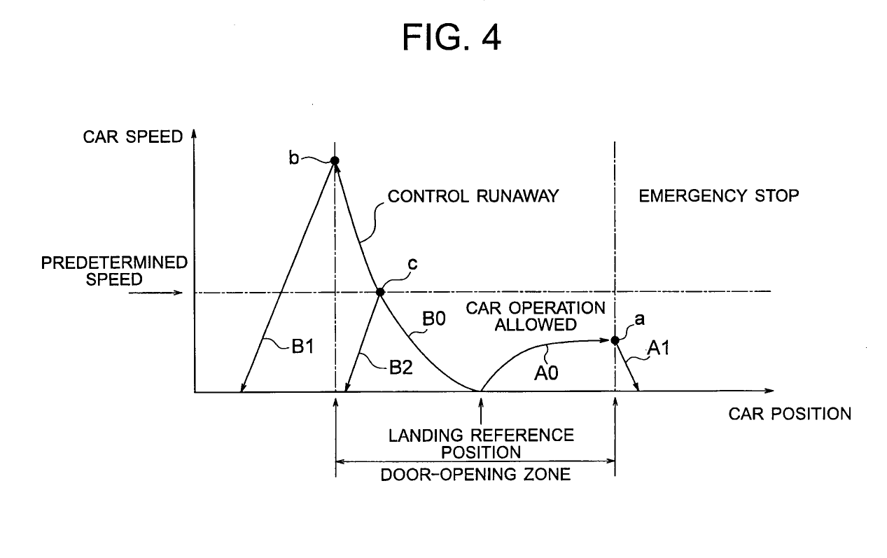

Next, the conventional elevator device as described in Patent Literature 1 and the elevator device according to Embodiment 1 are described in comparison with each other. FIG. 4 is an explanatory graph for illustrating a change in each of the car speed and the car position. In the case of the conventional elevator device, the fall prevention means of the control board confirms whether or not the car position is out of the door-opening zone when the car is in the door-open state and determines whether or not to actuate the rope gripper. Then, in the case of the conventional elevator device, when the car position exceeds the door-opening zone (point a shown in FIG. 4), for example, at the time of the floor alignment operation or the like, the raising/lowering of the car is quickly stopped by the rope gripper as indicated by arrows A0 and A1 illustrated in FIG. 4.

If the motor generates a maximum acceleration torque due to occurrence of an erroneous operation of a drive control system for the car such as control runaway at the time of the floor alignment operation in the conventional elevator device, the raising/lowering of the car is suddenly stopped at a time (point b shown in FIG. 4) at which the car position moves out of the door-opening zone after the car speed is increased to be fairly high as indicated by arrows B0 and B1 in FIG. 4. Specifically, in the case of the conventional elevator device as described in Patent Literature 1, the car is relatively abruptly decelerated as indicated by the arrow B1. Therefore, a relatively strong deceleration shock is applied to a user(s) in the car.

On the other hand, in the case of the elevator device according to Embodiment 1, when confirming that at least one of the car-speed condition and the car-position condition is satisfied after the confirmation of satisfaction of the door-open condition, the brake controller 50 quickly stops the raising/lowering of the car 6. Specifically, when confirming that the door-open condition and the car-position condition are both satisfied, the brake controller 50 quickly stops the raising/lowering of the car 6 as indicated by the arrows A0 and A1 in FIG. 4 as in the case of the conventional elevator device.

Moreover, when confirming that the door-open condition and the car-speed condition are both satisfied, specifically, at a time (point c shown in FIG. 4) at which the car speed becomes equal to or higher than a predetermined speed as indicated by the arrow B0 shown in FIG. 4, the brake controller 50 quickly stops the raising/lowering of the car 6 as indicated by an arrow B2. As a result, a duration of a continuous deceleration state becomes relatively short. Thus, the deceleration shock applied to the user(s) in the car 6 can be reduced as compared with that applied in the case where the conventional elevator device is used.

In addition, in the elevator device according to Embodiment 1, the car speed cannot exceed the predetermined speed. Thus, the car 6 can be stopped at a location relatively close to the door-opening zone. Therefore, the elevator device according to Embodiment 1 can deal with an unexpected operation of the car 6 with the door open without using the rope gripper used for the conventional elevator device as described in Patent Literature 1 nor further increasing the maximum braking force of the brake device 20. Specifically, the unexpected operation of the car 6 with the door open can be dealt with out using a brake lining with relatively high performance, a brake device with improved readiness for an immediate operation, a rope gripper provided in the hoistway (machine room) independently of the brake device 20, or the like. As a result, fabrication cost can be reduced.

Further, when the car 6 in the door-open state moves at a low speed (speed less than the predetermined speed), the brake controller 50 does not allow the emergency stop unless the car-position condition is satisfied. As a result, the emergency stop of the raising/lowering of the car 6 due to the erroneous operation at the time of the floor alignment operation can be avoided.

### Embodiment 2

In general, in elevator devices, relatively high operation-reliability is required for each of the sensors and the brake controller 50 so as to ensure higher safety. Therefore, in an elevator device according to Embodiment 2, the sensors (the hoisting-machine encoder 4, the car door opening/closing detector 11, and the landing-position detector 12) of Embodiment 1 are made redundant (are multiplexed).

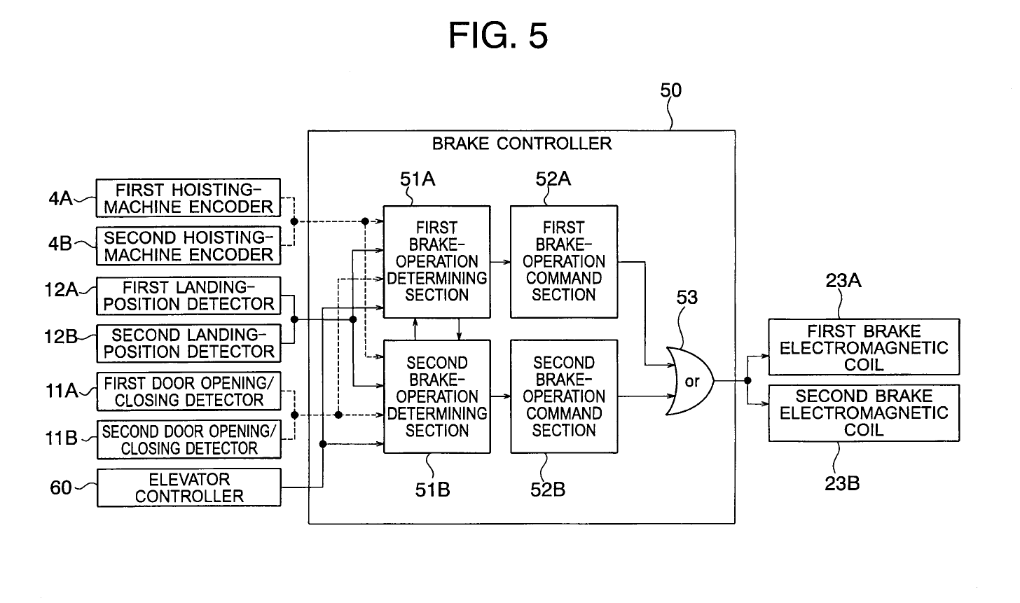

FIG. 5 is a block diagram illustrating a part of the elevator device according to Embodiment 2 of the present invention. In FIG. 5, as the hoisting-machine encoder 4 of Embodiment 1, a first hoisting-machine encoder 4A and a second hoisting-machine encoder 4B are used in the elevator device according to Embodiment 2. Moreover, as the car door opening/closing detector 11 of Embodiment 1, a first door opening/closing detector 11A and a second door opening/closing detector 11B are used.

Further, in Embodiment 2, as the landing-position detector 12 of Embodiment 1, a first landing-position detector 12A and a second landing-position detector 12B are used. The functions of the various sensors 4A, 4B, 11A, 11B, 12A, and 12B described above are the same as those of the devices 4, 11, and 12 of Embodiment 1.

Further, the brake controller 50 of Embodiment 2 includes a first brake-operation determining section 51A and a second brake-operation determining section 51B as the brake-operation determining section 51 of Embodiment 1. Further, the brake controller 50 includes a first brake-operation command section 52A and a second brake-operation command section 52B as the brake-operation command section 52 of Embodiment 1. The brake controller 50 further includes an OR operation section 53.

The first brake-operation determining section 51A and the second brake-operation determining section 51B receive a signal from each of the elevator controller and the sensors 4A, 4B, 11A, 11B, 12A, and 12B. The first brake-operation determining section 51A and the second brake-operation determining section 51B confirm whether or not the same type of signals from the sensors 4A, 4B, 11A, 11B, 12A, and 12B are identical with each other.

When the same type of signals are different from each other, the first brake-operation determining section 51A and the second brake-operation determining section 51B determine that any of the sensors 4A, 4B, 11A, 11B, 12A, and 12B may have a failure and causes the emergency stop and interrupts service so as to ensure safety.

Moreover, the first brake-operation determining section 51A and the second brake-operation determining section 51B compare the results of computations with each other so as to confirm whether or not the results of the same processing performed on the signals of the sensors 4A, 4B, 11A, 11B, 12A, and 12B are identical with each other. When the results are different from each other, the first brake-operation determining section 51A and the second brake-operation determining section 51B determine that any one of the brake-operation determining sections 51A and 51B including itself may have a failure and causes the emergency stop and interrupts service so as to ensure safety.

The results of computations of the first brake-operation command section 52A and the second brake-operation command section 52B are transmitted to the OR operation section 53. By the OR operation section 53, a logical sum of the brake operation is calculated. Specifically, even if any one of the first brake-operation command section 52A and the second brake-operation command section 52B has a failure, a configuration is such that the brake device 20 is actuated to ensure safety as long as the other one operates.

In the brake controller 50 of Embodiment 2, different pieces of hardware may be used respectively for the first brake-operation determining section 51A and the second brake-operation determining section 51B. Similarly, in the brake controller 50 of Embodiment 2, different pieces of hardware may be used respectively for the first brake-operation command section 52A and the second brake-operation command section 52B. The remaining functions of the brake controller 50 of Embodiment 2 and the remaining configuration and operation of the elevator device of Embodiment 2 are the same as those of Embodiment 1.

According to the elevator device of Embodiment 2 described above, the redundancy (multiplexing) is achieved by providing the first brake-operation determining section 51A and the second brake-operation determining section 51B, the first brake-operation command section 52A and the second brake-operation command section 52B, and the sensors 4A, 4B, 11A, 11B, 12A, and 12B. With the configuration described above, the occurrence of an abnormality in the sensors 4A, 4B, 11A, 11B, 12A, and 12B can be detected independently from the elevator controller 60. In addition, the safety and reliability against the failure of each device can be further improved.

In Embodiment 2, a duplexed configuration is provided by the first brake-operation determining section 51A and the second brake-operation determining section 51B, the first brake-operation command section 52A and the second brake-operation command section 52B, and the sensors 4A and 4B, 11A and 11B, and 12A and 12B. However, the configuration is not limited to the above-mentioned example. The devices and functions may have a triple or higher-order multiplexed configuration.

In Embodiment 2, the landing door opening/closing detector may also be made redundant.

### Embodiment 3

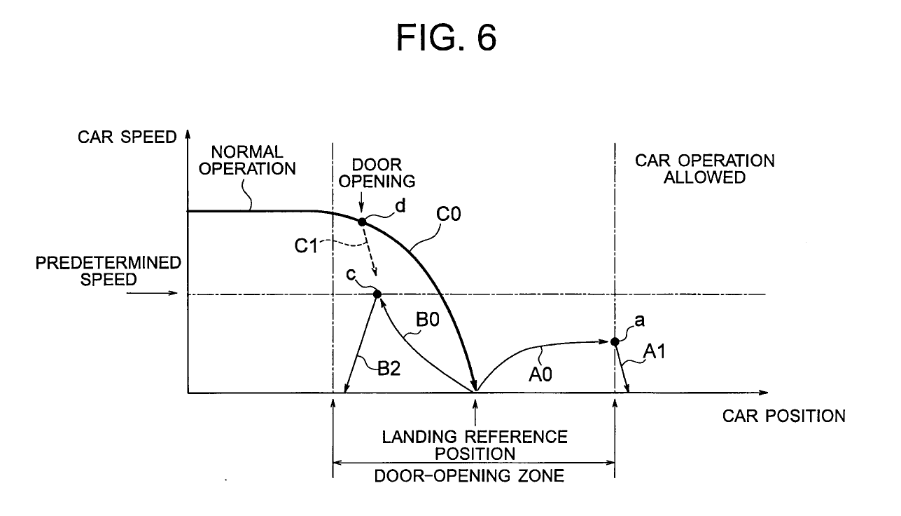

First, in general, the elevator devices employ a high-speed door-opening method for opening the car-door device relatively quickly to reduce a time period required to allow boarding/deboarding of the user(s) so as to improve travel efficiency. As one of the high-speed door-opening methods, a pre-landing door-opening method for starting opening the car-door device before the running position of the car completely reaches a floor position. The relation between the car speed and the car position in the case where the brake control method of the brake controller 50 according to Embodiment 1 is used for the elevator device employing the pre-landing door-opening method described above is described with reference to FIG. 6.

FIG. 6 is an explanatory graph for illustrating a change in each of the car speed and the car position in the case where each of the brake controllers 50 according to Embodiments 1 and 3 of the present invention is used. In FIG. 6, a change in each of the car speed and the car position in the case where the brake control method of the brake controller 50 according to Embodiment 1 is used for the elevator device employing the pre-landing door-opening method is indicated by an arrow C0 as a normal operation.

In the case where the brake control method of the brake controller 50 according to Embodiment 1 is used, if the car-door device starts opening at a time (point d shown in FIG. 6) at which the car 6 moves into the door-opening zone before stopping, the door-open state and a state in which the speed is equal to or higher than the predetermined speed are achieved. Therefore, the door-open condition and the car-speed condition are both satisfied. Accordingly, the raising/lowering of the car 6 is brought to an emergency stop as indicated by an arrow C1. Specifically, with the brake controller 50 of Embodiment 1, the emergency stop is unnecessarily made.

On the other hand, in the case of the elevator device of Embodiment 3, the brake controller 50 confirms whether or not a car-speed increase condition is satisfied in place of the confirmation of satisfaction of the car-speed condition of Embodiment 1. Then, when confirming that the door-open condition and the car-speed increase condition are both satisfied, the brake controller 50 controls the brake device 20 to demonstrate the braking force for quick stop.

The car-speed increase condition is a condition which is satisfied when the car position is within the door-opening zone and the car speed is increased (reaches) from a car speed lower than the predetermined speed to the predetermined speed or higher. If the car position within the door-opening zone moves out of the door-opening zone while the car-speed increase condition is satisfied, the car-speed increase condition is not satisfied any more.

Therefore, in the case of the elevator device of Embodiment 3, even if the car-door device starts opening at a time (point d) at which the car 6 moves into the door-opening zone before stopping, the raising/lowering of the car 6 is not brought to an emergency stop as indicated by the arrow C0 on the right of the point d. The brake controller 50 stores information of the change in each of the car speed and the car position in time series so as to be able to confirm the previous operation of the car 6. The remaining configuration of the elevator device according to Embodiment 3 is the same as that of at least one of Embodiments 1 and 2.

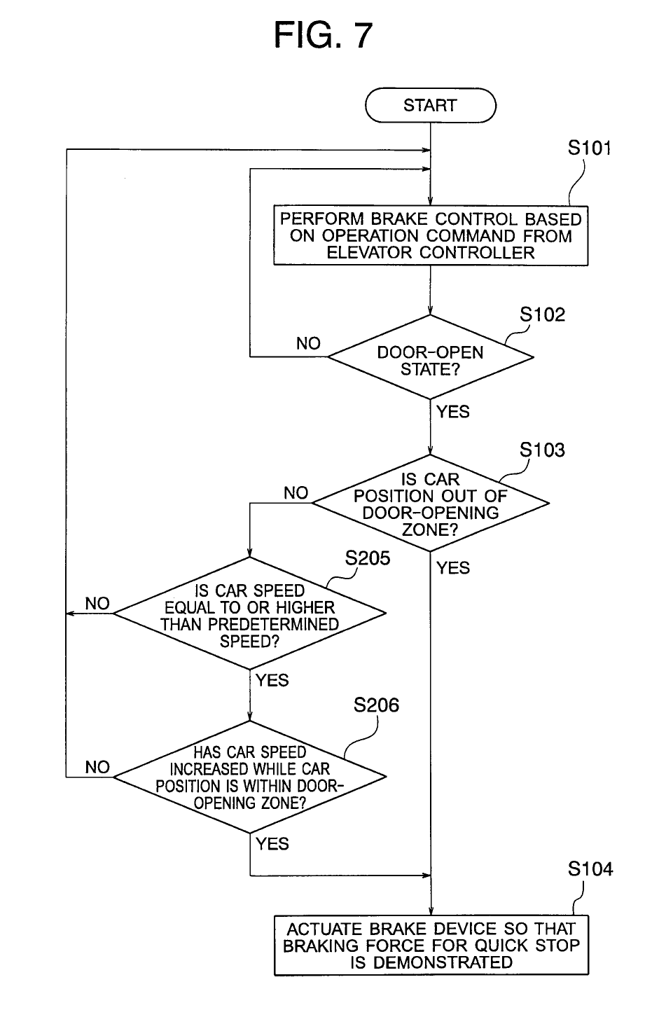

Next, an operation is described. FIG. 7 is a flowchart illustrating an operation of the brake controller 50 according to Embodiment 3 of the present invention. The operation of the brake controller 50 according to Embodiment 3 differs from that of the brake controller 50 of Embodiment 1 in an operation after the confirmation of the car position within the door-opening zone (operation after proceeding in No direction of Step S103 illustrated in FIG. 4). Here, only differences of the operation of the brake controller 50 according to Embodiment 3 from that of Embodiment 1 are described.

In FIG. 7, when confirming that the car position is within the door-opening zone (NO direction of Step S103), the brake controller 50 then confirms whether or not the car speed is equal to or higher than the predetermined speed (Step S205). When confirming that the car speed is equal to or higher than the predetermined speed in this step, the brake controller 50 then confirms whether or not the car speed has increased from the speed lower than the predetermined speed to the predetermined speed or higher while the car position is within the door-opening zone (door-opening zone corresponding to the current car position among the door-opening zones at the respective floors) (Step S206: confirmation of whether or not the car-speed increase condition is satisfied).

Then, when confirming that the car speed has increased from the speed lower than the predetermined speed to the predetermined speed or higher while the car position is within the door-opening zone (the car-speed increase condition is satisfied), the brake controller 50 actuates the brake device 20 so that the braking force for quick stop is demonstrated (Step S104). At the same time, the brake controller 50 places the power interruption switch 63 in the open state to interrupt the power supply to the hoisting machine 1. After that, the brake controller 50 waits until a reset operation is performed by an operator or a recovery operation by the elevator controller 60 is terminated.

On the other hand, when confirming that the car speed has increased from the speed lower than the predetermined speed to the predetermined speed or higher while the car position is out of the door-opening zone (the car-speed increase condition is not satisfied) (NO direction of Step S206), the brake controller 50 performs the brake control based on the operation command from the elevator controller 60 without controlling the brake device 20 to demonstrate the braking force for quick stop (Step S101) and repeats the same operation. The remaining operation of the brake controller 50 according to Embodiment 3 is the same as that of the brake controller 50 according to Embodiment 1.

According to the elevator device of Embodiment 3 as described above, when confirming that at least one of the car-position condition and the car-speed increase condition, and the door-open condition are both satisfied, the brake controller 50 controls the brake device 20 to demonstrate the braking force for emergency stop. Therefore, in the case where the car position is within the door-opening zone when the door-open condition is satisfied, the brake controller 50 does not allow the emergency stop of the raising/lowering of the car 6 unless the car-speed increase condition is satisfied even if the car speed is equal to or higher than the predetermined speed. As a result, in the case where the pre-landing door-opening method is employed, an unnecessary emergency stop of the raising/lowering of the car 6 can be avoided. In addition, the same effects as those of Embodiment 1 can be obtained.

### Embodiment 4

In general, in case of emergency stop due to, for example, power failure, the elevator device stops the car relatively slowly so as to further reduce the deceleration shock while conducting various types of safety check. In particular, if the deceleration and stop is started at a relatively high speed with a relatively large braking force, a state in which the deceleration is continuously relatively high persists. As a result, a burden due to the deceleration shock on a passenger(s) becomes large.

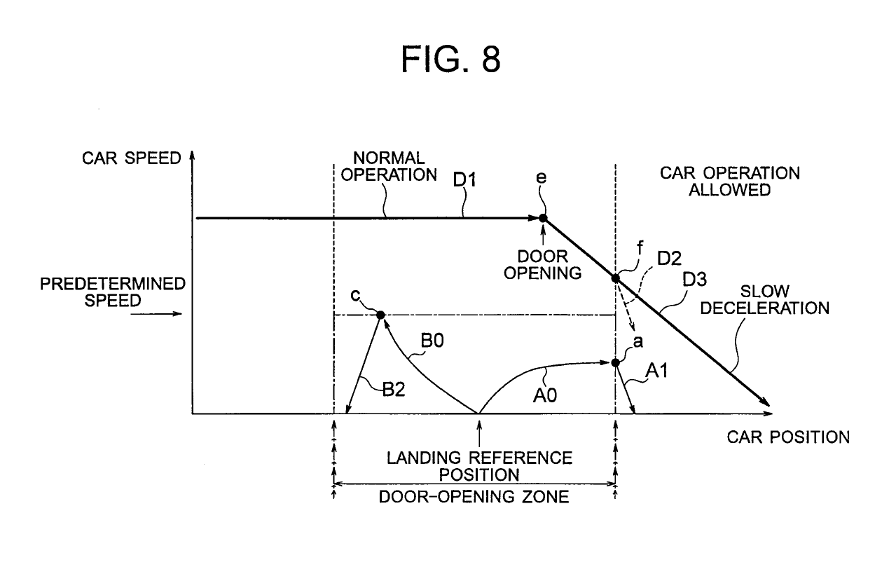

In this case, when at least one of the car-door device and the landing-door device is placed in the open state while the car is being raised or lowered, the elevator device generally performs the emergency stop of the raising/lowering of the car. Even in this case, the elevator device is required to employ a deceleration method in case of emergency, for performing the deceleration so as to prevent a stop distance from being unnecessarily long while further reducing the deceleration shock. The relation between the car speed and the car position in the case where the brake control method of the brake controller 50 according to Embodiment 3 is used for the elevator device employing the deceleration method in case of emergency described above is described with reference to FIG. 8.

FIG. 8 is an explanatory graph for illustrating a change in each of the car speed and the car position in the case where each of the brake controllers 50 according to Embodiments 3 and 4 of the present invention is used. In FIG. 8, the change in each of the car speed and the car position in the case where the brake control method of the brake controller 50 according to Embodiment 3 is used for the elevator device employing the deceleration method in case of emergency is indicated by an arrow D1 as a normal operation.

In FIG. 8, the car speed during the normal operation is higher than the predetermined speed. When the door is opened at a certain position (point e shown in FIG. 8), the car 6 decelerates slowly. Then, in the case where the brake control method of the brake controller 50 according to Embodiment 3 is used, the door-open condition and the car-position condition are both satisfied when the car position moves out of the door-opening zone while the car 6 is decelerating. Therefore, at a time (point f shown in FIG. 8) at which the car position moves out of the door-opening zone, the raising/lowering of the car 6 is suddenly stopped as indicated by an arrow D2. As a result, the deceleration shock becomes relatively strong.

On the other hand, in the case of the elevator device according to Embodiment 4, when confirming that the door-open condition and the car-speed condition are both satisfied, the brake controller 50 confirms whether or not the car-speed increase condition is satisfied. Then, when confirming that the car-speed increase condition is not satisfied, the brake controller 50 controls the brake device 20 to demonstrate the braking force for slowdown and stop so as to slow down and stop the raising/lowering of the car 6. On the other hand, when confirming that the car-speed increase condition is satisfied, the brake controller 50 controls the brake device 20 to demonstrate the braking force for quick stop so as to quickly stop the raising/lowering of the car 6.

When the brake controller 50 controls the brake device 20 to demonstrate the braking force for slowdown and stop, a state in which the brake device 20 demonstrates the braking force for slowdown and stop is continued as indicated by an arrow D3 on the right of the point f shown in FIG. 8 even if the brake controller 50 confirms that the door-open condition and the car-position condition are both satisfied. Therefore, as indicated by the arrow D3, the car 6 decelerates relatively slowly with the braking force for slowdown and stop of the brake device 20.

The correspondence relation between the condition for which the satisfaction is confirmed by the brake controller 50 of Embodiment 3 and the type of braking force to be demonstrated by the brake device 20 is now briefly described. When confirming that the door-open condition, the car-speed condition, and the car-speed increase condition are all satisfied, the brake controller 50 controls the brake device 20 to demonstrate the braking force for quick stop. When confirming that the door-open condition and the car-speed condition are both satisfied and the car-speed increase condition is not satisfied, the brake controller 50 controls the brake device 20 to demonstrate the braking force for slowdown and stop.

Further, when confirming that the door-open condition, the car-position condition, and the car-speed condition are all satisfied, the brake controller 50 controls the brake device 20 to demonstrate the braking force for slowdown and stop. When confirming that the door-open condition and the car-position condition are both satisfied and the car-speed condition is not satisfied, the brake controller 50 controls the brake device 20 to demonstrate the braking force for quick stop.

The brake controller 50 of Embodiment 4 stores information of the changes in each of the car speed and the car position in time series as in Embodiment 3 so as to be able to confirm the previous operation of the car 6. The remaining configuration of the elevator device according to Embodiment 4 is the same as that of Embodiment 3.

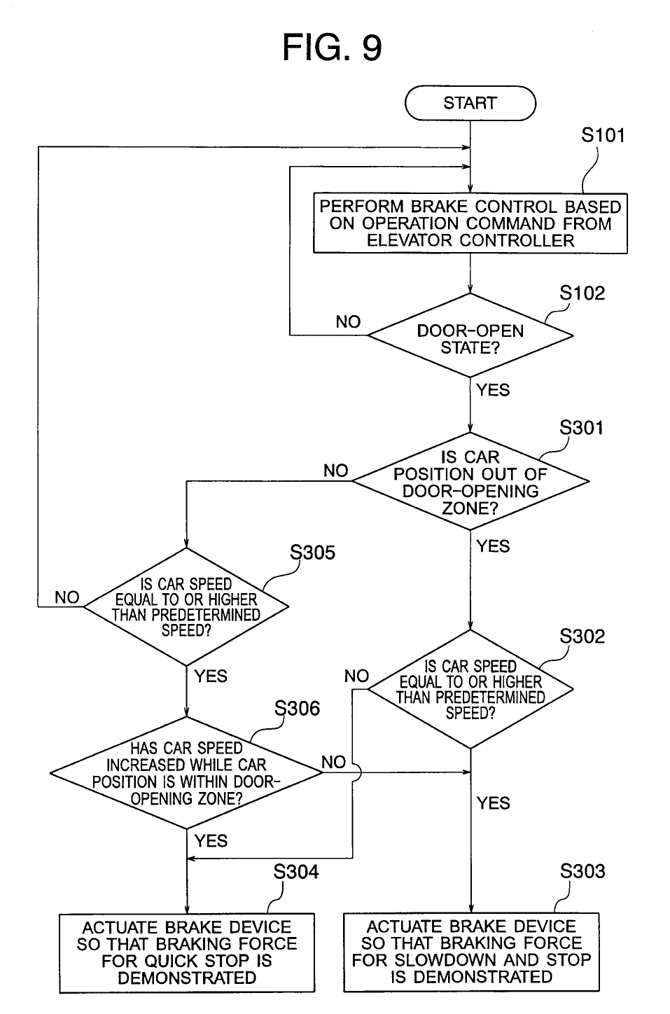

Next, an operation is described. FIG. 9 is a flowchart illustrating an operation of the brake controller 50 according to Embodiment 4 of the present invention. In FIG. 9, the brake controller 50 performs brake control based on the operation command from the elevator controller 60 when the car 6 is in a door-closed state (Step S101) and monitors whether or not the car 6 is placed in a door-open state (Step S102: confirmation of whether or not the door-open condition is satisfied).

Moreover, when confirming that the car 6 is placed in the door-open state (the door-open condition is satisfied) (Yes direction of Step S102), the brake controller 50 confirms whether or not the car position is out of the door-opening zone (Step S301: confirmation of whether or not the car-position condition is satisfied).

When confirming that the car position is out of the door-opening zone (the car-position condition is satisfied) in this step, the brake controller 50 confirms whether or not the car speed is equal to or higher than the predetermined speed (Step S302: confirmation of whether or not the car-speed condition is satisfied). Then, when confirming that the car speed is equal to or higher than the predetermined speed (the car-speed condition is satisfied), the brake controller 50 actuates the brake device 20 so that the braking force for slowdown and stop is demonstrated (Step S303).

On the other hand, when confirming that the car speed is lower than the predetermined speed (the car-speed condition is not satisfied) (NO direction of Step S302), the brake controller 50 actuates the brake device 20 so that the braking force for quick stop is demonstrated (Step S304).

Moreover, when confirming that the car position is within the door-opening zone (the car-position condition is not satisfied) (No direction of Step S301), the brake controller 50 then confirms whether or not the car speed is equal to or higher than the predetermined speed (Step S305: confirmation of whether or not the car-speed condition is satisfied).

When confirming that the car speed is lower than the predetermined speed (the car-speed condition is not satisfied) in this step (No direction of Step S305), the brake controller 50 performs the brake control based on the operation command from the elevator controller 60 without actuating the brake device 20 (Step S101) and repeats the same operation.

On the other hand, when confirming that the car speed is equal to or higher than the predetermined speed (the car-speed condition is satisfied) (YES direction of Step S305), the brake controller 50 then confirms whether or not the car speed has increased from the car speed lower than the predetermined speed to the predetermined speed or higher while the car position is within the door-opening zone (Step S306: confirmation of whether or not the car-speed increase condition is satisfied).

When confirming that the car speed has increased from the car speed lower than the predetermined speed to the predetermined speed or higher while the car position is within the door-opening zone (the car-speed increase condition is satisfied) (YES direction of Step S306), the brake controller 50 actuates the brake device 20 so that the braking force for quick stop is demonstrated (Step S304).

On the other hand, when confirming that the car speed has increased from the car speed lower than the predetermined speed to the predetermined speed or higher while the car position is out of the door-opening zone (the car-speed increase condition is not satisfied) (NO direction of Step S306), the brake controller 50 actuates the brake device 20 so that the braking force for slowdown and stop is demonstrated (Step S303).

When actuating the brake device 20 so that the braking force for slowdown and stop or the braking force for quick stop is demonstrated as in the case of the operations of Embodiments 1 and 3, the brake controller 50 places the power interruption switch 63 in the open state to interrupt the power supply to the hoisting machine 1. Thereafter, the brake controller 50 waits until a reset operation is performed by an operator or a recovery operation by the elevator controller 60 is terminated.

According to the elevator device of Embodiment 4 as described above, when confirming that the door-open condition and the car-speed condition are both satisfied and the car-speed increase condition is not satisfied, or when confirming that the door-open condition, the car-position condition, and the car-speed condition are all satisfied, the brake controller 50 controls the brake device 20 to demonstrate the braking force for slowdown and stop. As a result, in the case where the deceleration method in case of emergency is employed, an unnecessary emergency stop of the raising/lowering of the car 6 can be avoided. In addition, the same effects as those of Embodiment 1 can be obtained.

In the brake controller 50 according to Embodiments 3 and 4, the states of the car position and the car speed detected in time series may be stored in a plurality of storage sections. Specifically, the storage section of the hardware of the brake controller 50 may be made redundant. As a result, the brake controller 50 can more reliably detect the operation of the car 6.

Further, in the brake controller 50 of Embodiments 3 and 4, the previous states of the car position and the car speed may be confirmed by using the information stored in the elevator controller 60 without storing the previous states of the car position and the car speed detected in time series.

Further, in Embodiments 1 to 4, the hoisting-machine encoders 4, 4A, and 4B are used as the car-speed detection means to detect the speed of the car 6. However, the detection of the car speed is not limited to the above-mentioned example. For example, the brake controller 50 may detect the car speed using another sensor such as the governor encoder 16 or the acceleration detector 10 as the car-speed detection means. Similarly, for example, the brake controller 50 may detect the car position using another sensor such as the hoisting-machine encoder 4, the governor encoder 16, and the acceleration detector 10 as the car-speed detection means. In particular, if a sensor capable of constantly generating a signal according to an absolute position of the car 6 is used, the car speed can be obtained at the same time by performing differential processing on the signal by the brake controller 50.

Moreover, in Embodiments 1 to 4, a speed which cannot be generated at the time of the floor alignment operation is required to be set as the predetermined speed so as not to cause the emergency stop during the floor alignment operation of the car 6. For an elevator device which does not have the floor alignment function, however, a speed lower than the predetermined speed described in Embodiments 1 to 4 (for example, a speed lower than half of a rated speed) may be set.

In Embodiments 1 to 4, positions at a predetermined distance upwardly and downwardly away from a door-opening reference position are set as boundary positions (upper-limit position and lower-limit position) of the door-opening zone. Moreover, in Embodiments 1 to 4, the maximum allowable distance corresponding to a maximum distance at which the car in the door-open state can be separated away from the landing reference position, for example, during the car floor alignment operation is equal to a distance between a final stop position of the car which is suddenly stopped and the landing reference position when the car position is any one of the boundary positions of the door-opening zone and the car speed is the predetermined speed. In consideration of the positional relations described above, if an upper limit of the maximum allowable distance is uniquely defined in view of safety for preventing a stuck accident at the landing, a predetermined distance from the door-opening reference position (specifically, the door-opening zone) can be determined by the relation between the predetermined speed and the braking force for quick stop.

1. An elevator device, comprising:
a car which is raised and lowered in a hoistway;
an elevator-door device for opening/closing an elevator doorway including a doorway of the car;
a driving device for driving the raising/lowering of the car;
a brake device for braking the raising/lowering of the car;
an operation control section for controlling an operation of the car;
car-position detection means for generating a signal according to a position of the car;
car-speed detection means for generating a signal according to a running speed of the car;
door open/closed-state detection means for generating a signal according to an open/closed-state of the elevator-door device; and
a brake control section for controlling an operation of the brake device based on a command from the operation control section,
wherein the brake control section is configured to:
monitor the position of the car, the running speed of the car, and the open/closed state of the elevator-door device through an intermediation of the car-position detection means, the car-speed detection means, and the door open/closed-state detection means;
confirm whether or not each of a door-open condition which is satisfied when the elevator-door device is an open state, a car-position condition which is satisfied when the position of the car is out of a predetermined door-opening zone, and a car-speed condition which is satisfied when the running speed of the car is equal to or higher than a predetermined speed, is satisfied; and
control the brake device to demonstrate a braking force for quick stop for quickly stopping the car being raised and lowered when confirming that at least one of the car-position condition and the car-speed condition, and the door-open condition are both satisfied.

2. An elevator device, comprising:
a car which is raised and lowered in a hoistway;
an elevator-door device for opening/closing an elevator doorway including a doorway of the car;
a driving device for driving the raising/lowering of the car;
a brake device for braking the raising/lowering of the car;
an operation control section for controlling an operation of the car;
car-position detection means for generating a signal according to a position of the car;
car-speed detection means for generating a signal according to a running speed of the car;
door open/closed-state detection means for generating a signal according to an open/closed-state of the elevator-door device; and
a brake control section for controlling an operation of the brake device based on a command from the operation control section,
wherein the brake control section is configured to:
monitor the position of the car, the running speed of the car, and the open/closed state of the elevator-door device through an intermediation of the car-position detection means, the car-speed detection means, and the door open/closed-state detection means;
confirm whether or not each of a door-open condition which is satisfied when the elevator-door device is an open state, a car-position condition which is satisfied when the position of the car is out of a predetermined door-opening zone, and a car-speed increase condition which is satisfied when the position of the car is within the predetermined door-opening zone and the running speed of the car is changed from a running speed lower than a predetermined speed to the predetermined speed or higher, is satisfied; and
control the brake device to demonstrate a braking force for quick stop for quickly stopping the car being raised and lowered when confirming that at least one of the car-position condition and the car-speed increase condition, and the door-open condition are both satisfied.

3. An elevator device according to claim 2, wherein the brake control section is further configured to:
confirm whether or not a car-speed condition which is satisfied when the running speed of the car is equal to or higher than the predetermined speed is satisfied;
in a case of confirmation of satisfaction of both the car-speed condition and the door-open condition, control the brake device to demonstrate the braking force for quick stop when confirming the car-speed increase condition is satisfied, and control the brake device to demonstrate a braking force for slowdown and stop for slowing down and stopping the car when confirming the car-speed increase condition is not satisfied; and
in a case of confirmation of satisfaction of both the car-position condition and the door-open condition, control the brake device to demonstrate the braking force for slowdown and stop in place of the braking force for quick stop when confirming that the car-speed condition is satisfied, and control the brake device to demonstrate the braking force for quick stop when confirming that the car-speed condition is not satisfied.

4. An elevator device according to claim 1, wherein:
the brake control section includes:
a brake-operation determining section for confirming whether or not each of the door-open condition, the car-position condition, and the car-speed condition is satisfied to determine the operation of the brake device; and
a brake-operation command section for actuating the brake device according to the determination of the brake-operation determining section; and
each of the car-speed detection means, the door open/closed-state detection means, the car-position detection means, the brake-operation determining section, and the brake-operation command section is made redundant.
